(19) United States
(12) Patent Application Publication
(10) Pub. No.: US 2017/0066664 A1
(43) Pub. Date: Mar. 9, 2017

(54) CONNECTION TYPE REVERSE OSMOSIS (RO) WATER PURIFIER

(71) Applicant: Xiamen Runner Industrial Corporation, Xiamen (CN)

(72) Inventors: Yuan-zheng Sun, Xiamen (CN); Mang Lu, Xiamen (CN); Jing-ming Li, Xiamen (CN)

(21) Appl. No.: 15/228,935

(22) Filed: Aug. 4, 2016

(30) Foreign Application Priority Data
Sep. 9, 2015 (CN) 201520693513.5

(51) Int. Cl. C02F 1/44; B01D 61/02; C02F 1/28

(52) U.S. Cl. CPC C02F 1/441; C02F 1/283; B01D 61/025; B01D 2313/13; C02F 2201/007; C02F 2201/004

(57) ABSTRACT

A connection type Reverse Osmosis (RO) water purifier includes: at least two filter core wall seats, at least two filter cores, a connection member, and a connection tube. The at least two filter core wall seats are connected in series, with its one side provided with a water input port, and with its other side provided with at least a water output port. The at least two filter cores are each connected to bottom of each filter core wall seat. The connection member is used to connect two adjacent filter core wall seats through their sides. The connection tube is disposed on the water output port of the filter core wall seat, to connect to the water input port of an adjacent filter core wall seat. The connection type Reverse Osmosis (RO) water purifier is compact in structure, and is used to achieve modular connection.

### BACKGROUND OF THE INVENTION

Field of the Invention

The present invention relates to a water purifier, and in particular to a connection type Reverse Osmosis (RO) water purifier.

The Prior Arts

Presently on the market, the RO water purifier is of a fixed structure, thus it is not capable of realizing modular installation and function cooperation. Therefore, its assembly and installation are rather difficult, thus it is not capable of streamlining the production of the RO water purifiers.

Therefore, presently, the design and performance of the water purifier is not quite satisfactory, and it leaves much room for improvement.

### SUMMARY OF THE INVENTION

In view of the problems and drawbacks of the prior art, the present invention provides a connection type Reverse Osmosis (RO) water purifier, that is compact in structure, and can be formed through modular connection, to overcome the shortcomings of the prior art.

The present invention provides a connection type Reverse Osmosis (RO) water purifier, comprising: at least two filter core wall seats, at least two filter cores, a connection member, and a connection tube. The at least two filter core wall seats are connected in series, with its one side provided with a water input port, and with its other side provided with at least a water output port. The at least two filter cores are each connected to a bottom of each filter core wall seat. The connection member is used to connect two adjacent filter core wall seats through their sides. The connection tube is disposed on the water output port of the filter core wall seat, to connect to the water input port of an adjacent filter core wall seat.

In an aspect of the present invention, the connection member further includes: a plurality of nuts; a plurality of bolt holes, disposed on side faces of both sides of the filter core wall seats; and a plurality of connection bolts, each penetrating through each bolt hole on the side faces of two opposite sides of two adjacent filter core wall seats, to connect to each nuts to achieve connection through threading.

In another aspect of the present invention, the connection member further includes: two connection rods, disposed respectively at an upper position and a lower position between two adjacent filter core wall seats, such that the connection bolts penetrates through the connection rod, and then penetrates though the nut, to realize connection; and a fixing ring, disposed between an upper connection rod and a lower connection rod, to sleeve around a middle portion of the connection tube, to achieve connection with the connection tube through hinging.

In yet another aspect of the present invention, the connection member further includes: two tight seal rings, each disposed on each end of the connection tube.

In a further aspect of the present invention, the connection type Reverse Osmosis (RO) water purifier further includes: a water storage tank output port, a pure water output port, and a waste water output port, disposed respectively on an opposite side of the filter core wall seat.

In another aspect of the present invention, the filter core is a composite filter core, a RO filter core, or a carbon rod filter core.

Compared with the existing technology, the present invention has the advantages that, it is compact in construction, each element of filter core wall seat can be fixed through using the connection rod, the hexagonal bolts, and the hexagonal nuts, to realize easy deign of filter core wall seat, and modular connection of filter core wall seats. Further, in the present invention, the connection and replacement of filter core wall seats are made easy and simple, thus achieving standardization of RO water purifier, and streamlined production of the RO water purifier.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of connection type Reverse Osmosis (RO) water purifier according to an embodiment of the present invention before the filter cores are installed; and

FIG. 2 is a schematic diagram of connection type Reverse Osmosis (RO) water purifier according to an embodiment of the present invention after the filter cores are installed.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

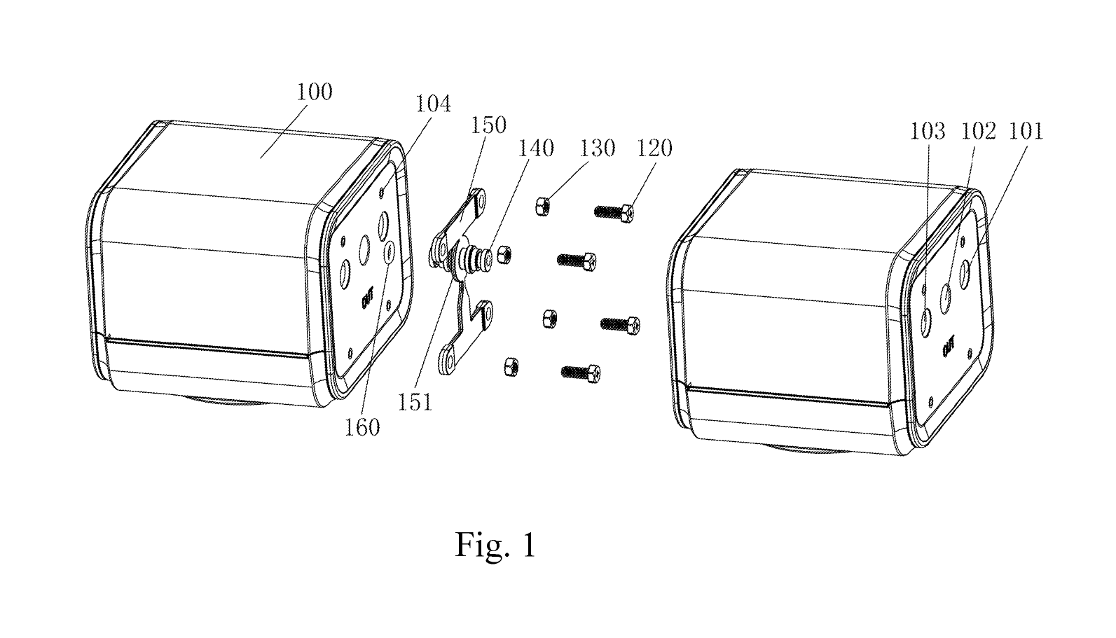

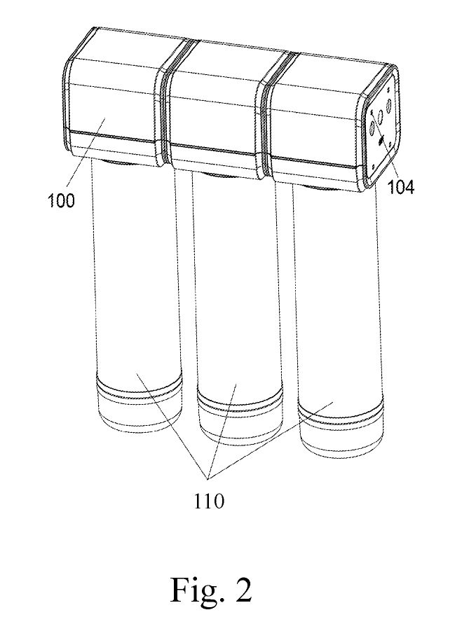

Refer to FIGS. 1 and 2 respectively for a schematic diagram of connection type Reverse Osmosis (RO) water purifier according to an embodiment of the present invention before the filter cores are installed; and a schematic diagram of connection type Reverse Osmosis (RO) water purifier according to an embodiment of the present invention after the filter cores are installed.

As shown in FIGS. 1 and 2, the connection type Reverse Osmosis (RO) water purifier comprises: at least two filter core wall seats 100, at least two filter cores 110, a connection member, and a connection tube 140. The at least two filter core wall seats 100 are connected in series, with its one side provided with a water input port, and with its other side provided with at least a water output port. On a side portion of the filter core wall seat is provided with hanging holes in connection with the wall body. The at least two filter cores 110 are each connected to a bottom of each filter core wall seat 100, and are used to filter raw water, so that the filtered water is output from the water output port. The connection member is used to connect two adjacent filter core wall seats 100 through their sides, to achieve modular connection of the RO water purifier. The connection tube 140 is disposed on the water output port of the filter core wall seat 100, to connect to the water input port of an adjacent filter core wall seat 100, to ensure water flowing through after two adjacent filter core wall seats 100 are connected together.

In an embodiment of the present invention, on an end face of a side of the filter core wall seat 100 is provided with a plurality of bolt holes 104, and on the end face of another side of the filter core wall seat 100 is further provided with a plurality of bolt holes 104, corresponding to that on the side of the adjacent filter core wall seat 100. The connection member further includes: a plurality of nuts 130; a plurality of bolt holes 104, disposed on side faces of both sides of the filter core wall seats 100; and a plurality of connection bolts 120, each penetrating through each bolt hole 104 on the side face of a side of the adjacent filter core wall seat 100, to connect to each nuts 130 to achieve connection through threading. The connection bolt can be a hexagon bolt having a cross slot on its head.

In an embodiment of the present invention, the connection member further includes: two connection rods 150, and a fixing ring 151. The two connection rods 150 are disposed respectively at an upper position and a lower position between two adjacent filter core wall seats 100, and are used to connect and position two adjacent filter core wall seats 100, thus bridging the gap between two adjacent filter core wall seats 100, and preventing them from moving. Both ends of the connection rod 150 are provided with through holes, such that the connection bolts 120 penetrates through the bolt holes on one side of the filter core wall seats 100, the through hole at one end of the connection rod 150, and the bolt holes on the opposite side of the adjacent filter core wall seat 100, and then penetrates though the nut 130, to realize connection. The fixing ring 151 is disposed between an upper connection rod 150 and a lower connection rod 150, to sleeve around a middle portion of the connection tube 140, to achieve connection with the connection tube 140 through hinging, and the positioning of the connection tube 140.

In an embodiment of the present invention, the connection member further includes: two tight seal rings 160, each disposed on each end of the connection tube 140, to provide tight seal and prevent water leakage for the connection to the water output port or the water input port of the filter core wall seats 100.

In an embodiment of the present invention, the connection type Reverse Osmosis (RO) water purifier further includes: a water storage tank output port 101, a pure water output port 102, and a waste water output port 130, disposed respectively on an opposite side of the filter core wall seat 100. In application, connection tubes 140 can be placed respectively on the water storage tank output port 101, the pure water output port 102, and the waste water output port 130. Alternatively, a connection tubes 140 can be placed on the pure water output port 102, while a blocking piece can be placed on the water storage tank output port 101 and the waste water output port 103.

In another aspect of the present invention, the filter core is a composite filter core, a RO filter core, or a carbon rod filter core.

In the operation of the connection type Reverse Osmosis (RO) water purifier, firstly, open the upper cover of the filter core wall seat 100. Next, connect the connection tube 140 to the water input port and the water output port. Then, pass the bolt through the bolt hole, the connection rod 150, and bolt holes on the adjacent filter core wall seat 100, and to be connected to the nut 130 in the adjacent filter core wall seat 100 through threading, in achieving connecting of the filter core wall seats 100 into a unit.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A connection type Reverse Osmosis (RO) water purifier, comprising:
at least two filter core wall seats connected in series, with its one side provided with a water input port, and with its other side provided with at least a water output port;
at least two filter cores, each connected to a bottom of each filter core wall seat;
a connection member, used to connect two adjacent filter core wall seats through their sides; and
a connection tube, disposed on the water output port of the filter core wall seat, to connect to the water input port of an adjacent filter core wall seat.

2. The connection type Reverse Osmosis (RO) water purifier as claimed in claim 1, wherein the connection member includes:
a plurality of nuts;
a plurality of bolt holes, disposed on side faces of both sides of the filter core wall seat; and
a plurality of connection bolts, each penetrating through each bolt hole on the side faces of two opposite sides of two adjacent filter core wall seats, to connect to each nuts to achieve connection through threading.

3. The connection type Reverse Osmosis (RO) water purifier as claimed in claim 2, wherein the connection member further includes:
two connection rods, disposed respectively at an upper position and at a lower position between two adjacent filter core wall seats, such that the connection bolts penetrate through the connection rod, and then penetrates though the nut, to realize connection; and
a fixing ring, disposed between an upper connection rod and a lower connection rod, to sleeve around a middle portion of the connection tube, to achieve connection with the connection tube through hinging.

4. The connection type Reverse Osmosis (RO) water purifier as claimed in claim 3, wherein the connection member further includes: two tight seal ring, each disposed on each end of the connection tube.

5. The connection type Reverse Osmosis (RO) water purifier as claimed in claim 1, further comprising: a water storage tank output port, a pure water output port, and a waste water output port, disposed respectively on an opposite side of the filter core wall seat.

6. The connection type Reverse Osmosis (RO) water purifier as claimed in claim 1, wherein the filter core is a composite filter core, a RO filter core, or a carbon rod filter core.
